(19) United States
(12) Patent Application Publication
(10) Pub. No.: US 2010/0226656 A1
(43) Pub. Date: Sep. 9, 2010

(54) OPTICAL WAVEGUIDE, LIGHT TRANSMISSION APPARATUS, AND ELECTRONIC EQUIPMENT

(75) Inventors: Takehiro Niitsu, Kanagawa (JP); Akira Sakamoto, Kanagawa (JP); Masahiro Yoshikawa, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/540,572

(22) Filed: Aug. 13, 2009

(30) Foreign Application Priority Data
Mar. 3, 2009 (JP) 2009-048807

(51) Int. Cl. H04B 10/12; G02B 6/26; H04B 10/00

(52) U.S. Cl. 398/139; 385/43; 398/200

(57) ABSTRACT

An optical waveguide includes a first waveguide region and a second waveguide region. The first waveguide region includes a first core, a first clad provided around the first core, and a light reflecting surface. The light reflecting surface has at least one function of (i) reflecting light from a longitudinal direction of the first core toward a direction crossing the longitudinal direction and (ii) reflecting light from the crossing direction toward the longitudinal direction of the first core. The second waveguide region continues from the first waveguide region. The second waveguide region that includes a second core, and a second clad provided around the second core. The second core of the second waveguide region is thinner than the first core of the first waveguide region. A total thickness of the second core and the second clad is smaller than that of the first core and the first clad.

### CROSS-REFERENCE TO RELATED APPLICATIONS

This application is based on and claims priority under 35 USC 119 from Japanese Patent Application No. 2009-48807 filed on Mar. 3, 2009.

### BACKGROUND

1. Technical Field

The present invention relates to an optical waveguide, a light transmission apparatus, and electronic equipment.

2. Related Art

As light transmission apparatuses, there are light transceivers which conduct communication using an optical waveguide connected between a transmitter and a receiver. There are systems in which light reflecting surfaces are respectively provided at both ends of an optical waveguide, light emitted from a light emitting device, such as a vertical cavity surface emitting laser, provided in a transmitter is input into the optical waveguide via the light reflecting surface at one end of the optical waveguide, and light transmitted into the optical waveguide is output via the light reflecting surface at the other end of the optical waveguide to a light receiving device, such as a photodiode (PD), provided in a receiver.

### SUMMARY

According to an aspect of the invention, an optical waveguide includes a first waveguide region and a second waveguide region. The first waveguide region includes a first core, a first clad provided around the first core, and a light reflecting surface. The light reflecting surface has at least one function of (i) reflecting light from a longitudinal direction of the first core toward a direction crossing the longitudinal direction and (ii) reflecting light from the crossing direction toward the longitudinal direction of the first core. The second waveguide region continues from the first waveguide region. The second waveguide region that includes a second core, and a second clad provided around the second core. The second core of the second waveguide region is thinner than the first core of the first waveguide region. A total thickness of the second core and the second clad is smaller than that of the first core and the first clad.

### BRIEF DESCRIPTION OF THE DRAWINGS

FIGS. 1A to 1D are views showing an optical waveguide according to one exemplary embodiment of the present invention, FIG. 1 being a longitudinal sectional view of the waveguide, FIG. 1B being a plan view thereof, FIG. 1C being a left side view and FIG. 1D being a right side view;

FIGS. 2A and 2B are views for explaining a relationship between thickness of a core near a light reflecting surface and tolerance in alignment, FIG. 2A showing the case where the core has small thickness and FIG. 2B showing the case where the core has large thickness;

FIGS. 3A and 3B are views showing an example of a result of simulation for an insertion loss when thickness of a core of an optical waveguide is changed, FIG. 3A showing the configuration of an optical waveguide used for the simulation and FIG. 3B being a graph showing the simulation result;

FIGS. 4A and 4B are views showing an example of a result of simulation for an insertion loss caused by an optical axis misalignment between a light emitting device (vertical cavity surface emitting laser) and a light reflecting surface of an optical waveguide, FIG. 4A showing the configuration of an optical waveguide used for the simulation and FIG. 4B being a graph showing the simulation result;

FIGS. 5A and 5B are views showing an example of a result of simulation for an insertion loss caused by an optical axis misalignment between a light emitting device (vertical cavity surface emitting laser) and a light reflecting surface of an optical waveguide, FIG. 5A showing the configuration of an optical waveguide used for the simulation and FIG. 5B being a graph showing the simulation result;

FIG. 6 is a view showing an optical waveguide according to another exemplary embodiment of the present invention;

FIGS. 7A and 7B are views showing examples of a relationship between a PD light receiving area and a light reflecting surface of an optical waveguide, FIG. 7A showing a state where no taper part is provided and FIG. 7B showing a state where a taper part is provided;

FIGS. 8A to 8H are views showing examples of various shapes of an optical waveguide having a taper part;

FIGS. 9A to 9F are views showing examples of a method of forming a taper part on an optical waveguide;

FIGS. 10A and 10B are views showing examples of a method of forming a light reflecting surface on an optical waveguide;

FIG. 11 is a view showing a light transmission apparatus using the optical waveguide according to one exemplary embodiment of the present invention;

FIGS. 12A and 12B are views showing electronic equipment on which the light transmission apparatus using the optical waveguide is mounted according to one exemplary embodiment of the present invention, FIG. 12A showing a light transmission apparatus having a bendable optical waveguide and FIG. 12B showing an example where the light transmission apparatus is mounted on a mobile phone as the electronic equipment; and

FIG. 13 is a view showing an example of a state where the optical waveguide according to one exemplary embodiment of the present invention is bent in a waveguide longitudinal direction.

### DETAILED DESCRIPTION

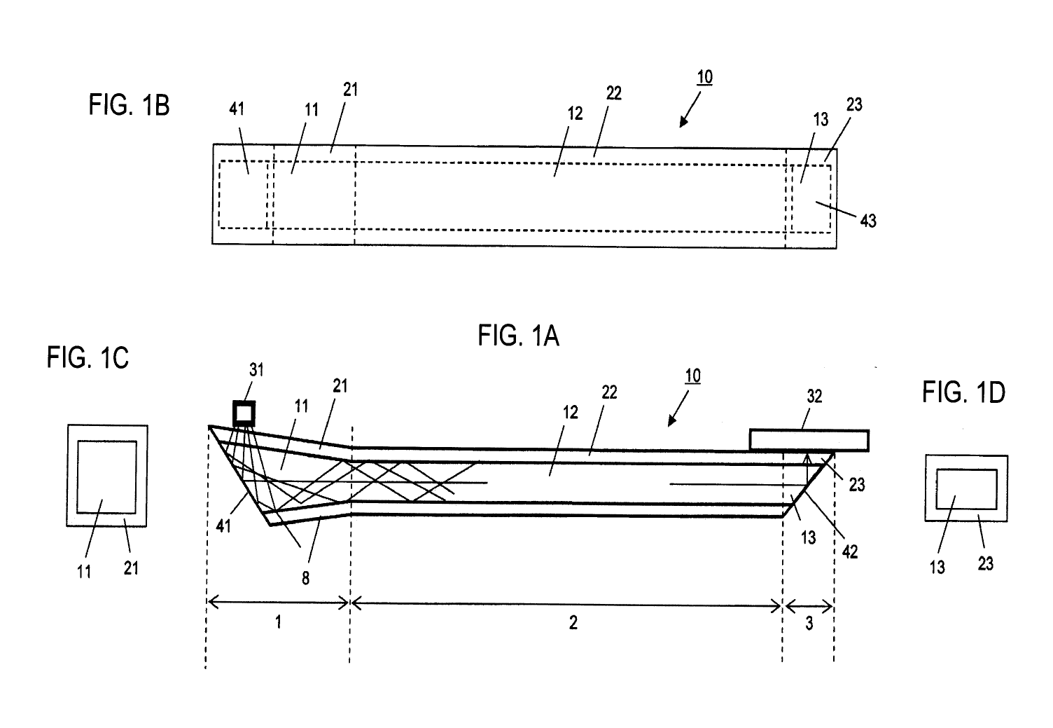

FIGS. 1A to 1D are views showing an optical waveguide according to one exemplary embodiment of the present invention. FIG. 1A is a longitudinal sectional view of the waveguide, FIG. 1B is a plan view thereof, FIG. 1C is a left side view and FIG. 1D is a right side view. As shown, an optical waveguide 10 includes a first waveguide region 1 and a second waveguide region 2. The first waveguide region 1 has a core 11, a clad 21 provided around the core 11, and a light reflecting surface 41. The light reflecting surface 41 reflects light from a longitudinal direction of the core 11 toward a direction crossing the longitudinal direction or reflects light from the direction crossing the longitudinal direction toward the longitudinal direction of the core 11. The second waveguide region 2 continues from the first waveguide region 1. The second waveguide region 2 has a core 12 and a clad 22 provided around the core 12. The core 12 of the second waveguide region 2 is thinner than the core 11 of the first waveguide region 1. A total thickness of the core 12 and the clad 22 is smaller than that of the core 11 and the clad 21 of the first waveguide region 1. In addition, as shown, although not essential, the optical waveguide 10 may include a third waveguide region 3 which continues from the second waveguide region 2 on the opposite side to the first waveguide region 1. The third waveguide region 3 has a core 13, a clad 23 provided around the core 13, and a light reflecting surface 42. The light reflecting surface 42 reflects light from the longitudinal direction of the core 13 toward a direction crossing the longitudinal direction or reflects light from the direction crossing the longitudinal direction of the core 13 toward the longitudinal direction of the core 13. A thickness relationship between the core and clad of the second waveguide region 2 and the core and clad of the third waveguide region 3 may be equivalent to the thickness relation between the core and clad of the second waveguide region 2 and the core and clad of the first waveguide region 1. That is, the second waveguide region 2 may be thinner than both the first waveguide region and the third waveguide region, and may be bendable in the waveguide longitudinal direction, which will be described in detail later. In this exemplary embodiment, the optical waveguide 10 is optically coupled with a light emitting device 31, such as a vertical cavity surface emitting laser, via the light reflecting surface 41 in the first waveguide region 1 and is further optically coupled with a light receiving device 32, such as a photodiode (PD), via the light reflecting surface 42 in the third waveguide region 3.

As shown in the figure, the first waveguide region 1 has a taper part 8 in which the thickness of the core 11 gets smaller gradually toward the second waveguide region 2. In this exemplary embodiment, although the light reflecting surface 41 is formed at an opposite end of the taper part 8 to the second waveguide region 2, the light reflecting surface 41 is not limited to this configuration. For example, the taper part 8 may be formed at a position spaced from the light reflecting surface 41 to the second waveguide region 2, which will be described in detail later. In addition, in this exemplary embodiment, although the inclination of the taper part 8 on one side in which the light emitting device 31 is arranged is larger than the inclination of the taper part 8 on the opposite side thereof, the inclinations of the taper parts 8 are not limited thereto.

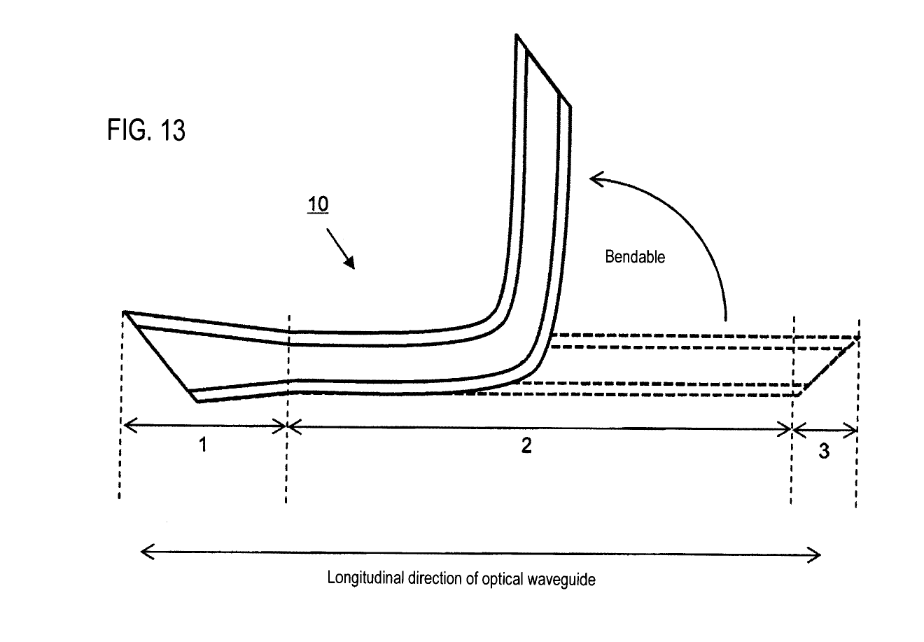

In this manner, in this exemplary embodiment, the thickness of the core 12 of the second waveguide region 2 is smaller than that of the core 11 of the first waveguide region 1, and the total thickness of the core and clad of the second waveguide region 2 is smaller than that of the core and clad of the first waveguide region 1, which thus allows the optical waveguide to be bent in the waveguide longitudinal direction. In this case, the expression “bendable in the waveguide longitudinal direction” means to bend the optical waveguide in a direction in which the third waveguide region 3 of the optical waveguide 10 is lifted upward or pressed downward, for example, as shown in FIG. 13. In the example of FIG. 13, the optical waveguide 10 is bent in an L shape. However, the bending manner is limited thereto. The optical waveguide 10 may be bent in any other shape, such as an S shape or a wave shape, by, for example, increasing the length of the second waveguide region 2. That is, the optical waveguide of this exemplary embodiment is bendable in the waveguide longitudinal direction, has a light reflecting surface at at least one end thereof, and is configured such that the core near the at least one light reflecting surface gets is thicker than the central portion of the optical waveguide. In addition, the optical waveguide is configured such that a portion of the optical waveguide near the at least one light reflecting surface gets larger in the total thickness of the optical waveguide including the clad than the central portion of the optical waveguide as the core gets thicker. In addition, the optical waveguide has the taper part(s) where the core gets thinner gradually from the portion of the optical waveguide near the light reflecting surface, and a parallel part having a constant core thickness of the core in the central portion of the optical waveguide. A bendable portion of the optical waveguide is formed in the central portion of the optical waveguide.

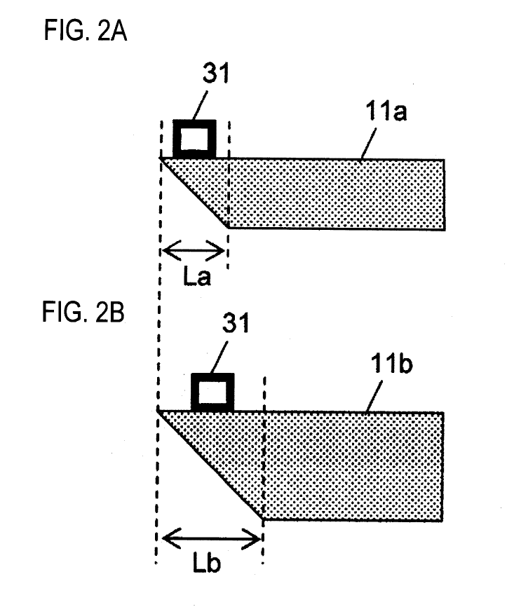

With the above configuration, the central portion of the optical waveguide, which is required to have flexibility, can be made thin, and a portion requiring alignment between the light emitting device such as a vertical cavity surface emitting laser (VCSEL) and the light reflecting surface can be made thinker than the central portion, thereby providing wide tolerance for alignment. FIGS. 2A and 2B are views for explaining the relationship between the thickness of the core near the light reflecting surface and tolerance in alignment. FIG. 2A shows the core having small thickness, and FIG. 2B shows the core having large thickness. As shown in FIG. 2A, if thickness of a core 11 a is small, a length La of the light reflecting surface in the waveguide longitudinal direction when viewed from the light emitting device 31 is small. However, as shown in FIG. 2B, if the thickness of the core 11b is large, a length Lb of the light reflecting surface in the waveguide longitudinal direction when viewed from the light emitting device 31 is large as compared to the case where the thickness of the core is small. That is, by making the thickness of the core large, a wide assembly tolerance can be set, which results in high productivity and a reduction in the time and costs required for aligning the light emitting device 31.

Polymers used as material for the optical waveguide (core and clad) may include, but are not limited to, PMMA (polymethylmetacrylate), polyimide-based resin (polyimide resin, poly(imide-isoindoloquinazolinedionimide) resin, polyetherimide resin, polyetherketone resin, polyesterimide resin, etc.), silicon-based resin, polystyrene-based resin, polycarbonate-based resin, polyamide-based resin, polyester-based resin, phenol-based resin, polyquinoline-based resin, polyquinoxaline-based resin, polybenzooxazole-based resin, polybenzotiazole-based resin, polybenzoimidazole-based resin, polycarbonate resin, polyolefine-based resin, etc. Refractive indexes of the core and the clad are, for example, 1.55 and 1.52, respectively. In this case, a refractive index difference An is 1.93%, and a numerical aperture (NA) of the optical waveguide is 0.3. However, the refractive index difference and the numerical aperture are not limited thereto.

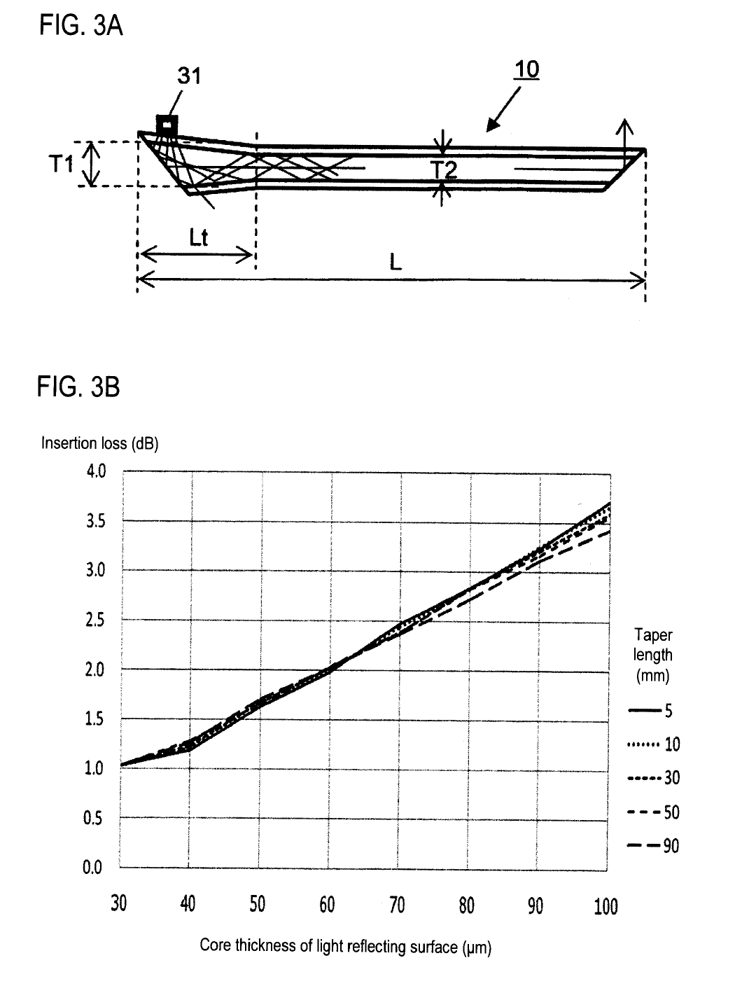

FIGS. 3A and 3B are views showing an example of a result of simulation for an insertion loss when thickness of the core of the optical waveguide is changed. FIG. 3A shows the configuration of the optical waveguide used for the simulation, and FIG. 3B is a graph showing the simulation result. In FIG. 3A, the total length L of the optical waveguide is 100 mm, the thickness T2 of the core of the central portion of the optical waveguide is 30 μm, a distance Z between the light emitting device (vertical cavity surface emitting laser) and the optical waveguide is 0 μm (closely adhered to), a laser irradiation angle is 30 degrees, and a core thickness T1 of the light reflecting surface and a taper length Lt are varied. As can be seen from the graph of FIG. 3B, when the core thickness T1 of the light reflecting surface is varied from 30 μm to 100 μm, the insertion loss is substantially determined by the core thickness T1, and a difference in the taper length Lt causes less difference in insertion loss. In this example, while it is assumed that the total length L of the optical waveguide is 100 mm, a difference in insertion loss between taper lengths of 5 mm and 90 mm is 0.2 dB or so, according to this result. The taper length Lt can be set desirably in the range of the total length of the optical waveguide. However, in view of this result, the taper length Lt may be set as small as possible in order to widen the region in which the optical waveguide has flexibility.

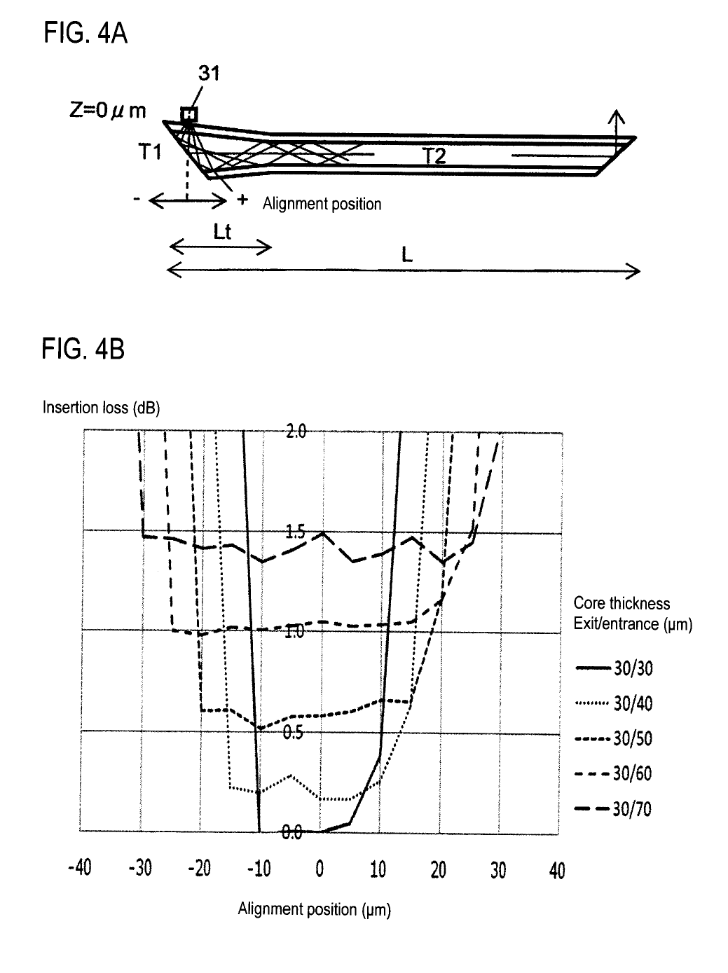

FIGS. 4A and 4B are views showing an example of a result of simulation for an insertion loss caused by an optical axis misalignment between a light emitting device (vertical cavity surface emitting laser) and a light reflecting surface of an optical waveguide. FIG. 4A shows the configuration of the optical waveguide used for the simulation. FIG. 4B is a graph showing the simulation result. This example shows a misalignment loss in a state where the vertical cavity surface emitting laser and the optical waveguide are closely adhered to each other (Z=0). In FIG. 4A, the total length L of the optical waveguide is 100 mm, the taper length Lt is 5 mm, the laser irradiation angle is 30 degrees, the thickness T2 (exit) of the core in the central portion of the optical waveguide is 30 μm, the core thickness T1 (entrance) of the light reflecting surface is varied to 30 μm, 40 μm, 50 μm, 60 μm and 70 μm. As can be seen from the graph of FIG. 4B, if the misalignment loss of, for example, 1.2 dB is acceptable, a tolerance in the case where the vertical cavity surface emitting laser is closely adhered is −25 μm to +20 μm in the taper waveguide having the entrance core thickness of 60 μm, which is two times as wide as the tolerance (±11 μm) of a waveguide having no taper (exit/entrance core thickness: 30/30 μm).

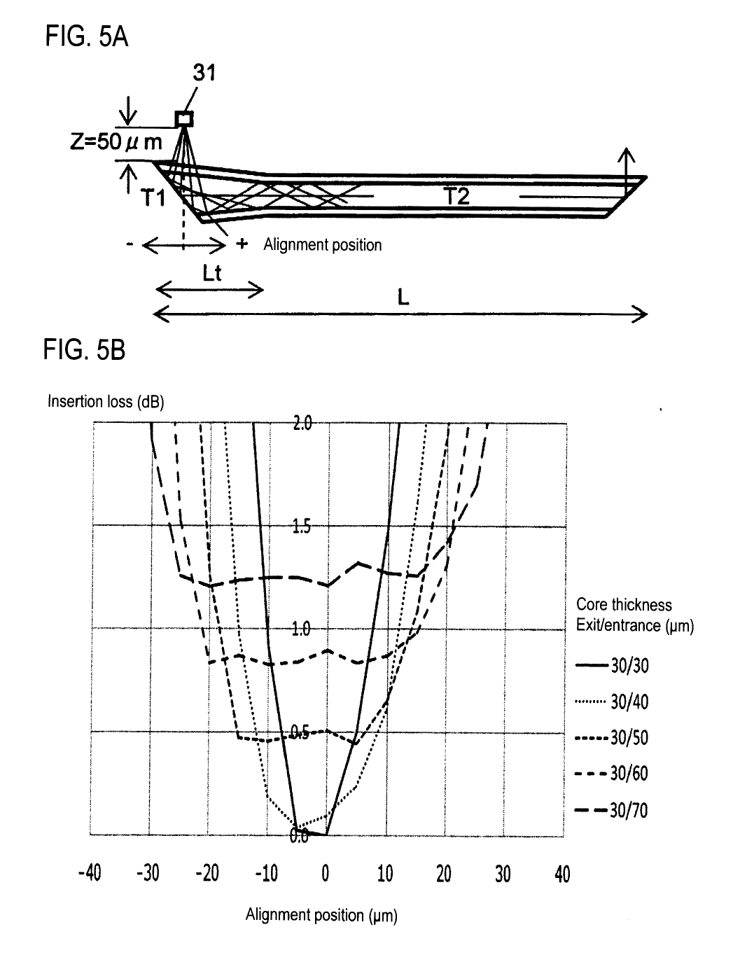

FIGS. 5A and 5B are views showing an example of a result of simulation for an insertion loss caused by an optical axis misalignment between a light emitting device (vertical cavity surface emitting laser) and a light reflecting surface of an optical waveguide. FIG. 5A showing the configuration of an optical waveguide used for a simulation, and FIG. 5B is a graph showing the simulation result. This example shows a misalignment loss in a state where a distance Z between the vertical cavity surface emitting laser and the optical waveguide is 50 μm. In FIG. 5A, the total length L of the optical waveguide is 100 mm, the taper length Lt is 5 mm, the laser irradiation angle is 30 degrees, the thickness T2 (exit) of the core in the central portion of the optical waveguide is 30 μm, the core thickness T1 (entrance) of the light reflecting surface is varied to 30 μm, 40 μm, 50 μm, 60 μm and 70 μm. As can be seen from the graph of FIG. 5B, if the misalignment loss of, for example, 1 dB is acceptable, a tolerance in the state where the distance Z between the vertical cavity surface emitting laser and the optical waveguide is 50 μm is −21 μm to +15 μm in the taper waveguide having the entrance core thickness of 60 μm, which is also two times as wide as a tolerance of −10 μm to +8 μm of a waveguide having no taper.

In this manner, by making a portion of the waveguide near the light reflecting surface through which light beams are input from the light emitting device (vertical cavity surface emitting laser) thicker than the central portion, it is possible to widen the alignment tolerance. This may result in a wide assembly tolerance and high productivity. Thickness of the waveguide near the light reflecting surface can be selected in accordance with an assembly tolerance in the manufacturing process. For example, if there is no need to take the tolerance to double or more, the thickness of the waveguide may be adjusted to be small.

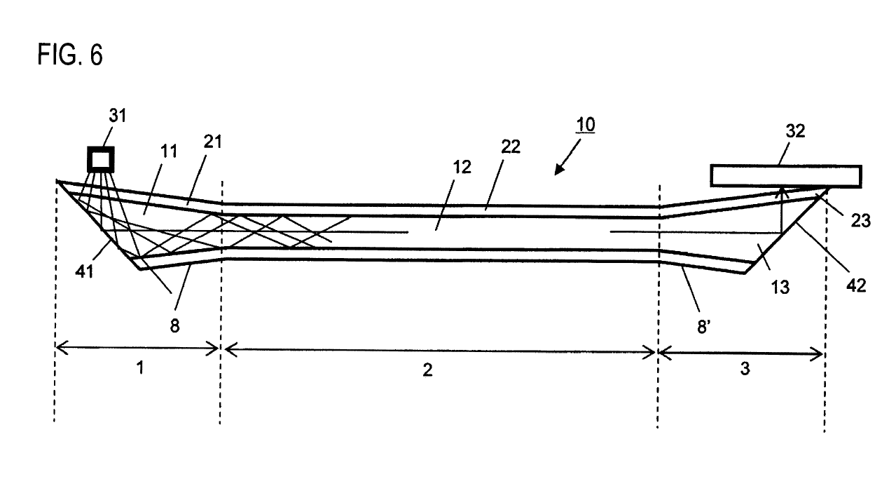

FIG. 6 is a view showing an optical waveguide according to another exemplary embodiment of the present invention. In this exemplary embodiment, the optical waveguide includes a third waveguide region 3 which continues from the second waveguide region 2 on the opposite side to the first waveguide region 1. The third waveguide region 3 has the inversion configuration of the first waveguide region 1 in terms of the waveguide longitudinal direction. That is, the optical waveguide of this exemplary embodiment is configured such that taper parts 8 and 8′ are formed near the light reflecting surfaces 41 and 42 on both sides of the optical waveguide 10, respectively. The thicknesses of the cores of those taper parts are larger than that of the core of the central portion of the optical waveguide. In this exemplary embodiment, the optical waveguide 10 is optically coupled with the light emitting device 31, such as a vertical cavity surface emitting laser, via the light reflecting surface 41 in the first waveguide region 1. The optical waveguide 10 is further optically coupled with the light receiving device 32, such as a photodiode (PD), via the light reflecting surface 42 in the third waveguide region 3.

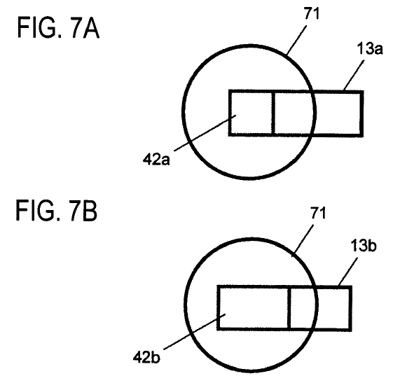

Paying close attention to the third waveguide region 3, if a transmission band of an optical signal is, for example, 1 GHz or so, there is no alignment problem since a PD light reception diameter of 100 μm or above may be used. On the other hand, emission of light into a portion of an effective area of the PD may cause a space charge effect, which may result in poor signal response and hence increased jitter. In order to reduce such a space charge effect, it is effective to increase the light irradiation area onto the PD light receiving area. This exemplary embodiment aims at improving this signal response and will be described below with reference to FIG. 7.

FIGS. 7A and 7B are views showing an example of a relation between a PD light receiving area and a light reflecting surface of an optical waveguide. FIG. 7A shows a state where no taper part is provided, and FIG. 7B shows a state where a taper part is provided. In the state where no taper part is provided, as shown in FIG. 7A, a ratio of an area (for example, 30 μm×30 μm) of a light reflecting surface 42a of a core 13a to the PD light receiving area 71 (for example, its diameter: 100 μm) is small. Accordingly, the diameter of the light receiving spot of the PD light receiving area is small and is likely to cause the space charge effect, thereby resulting in poor signal response. On the other hand, in the state where a taper part is provided, as shown in FIG. 7B, a ratio of an area (for example, 30 μm×50 μm) of a light reflecting surface 42b of a core 13b to the PD light receiving area 71 (for example, its diameter: 100 μm) is larger than the case shown in FIG. 7A. Accordingly, the diameter of the light receiving spot of the PD light receiving area is large, thereby preventing the space charge effect, resulting in improvement of signal response. In this manner, by making the thickness of the core near the light reflecting surface of the PD side be larger than that of the central portion of the optical waveguide, it is possible to reduce the space charge effect of the PD, thereby resulting in an improvement of the quality of the transmission signal.

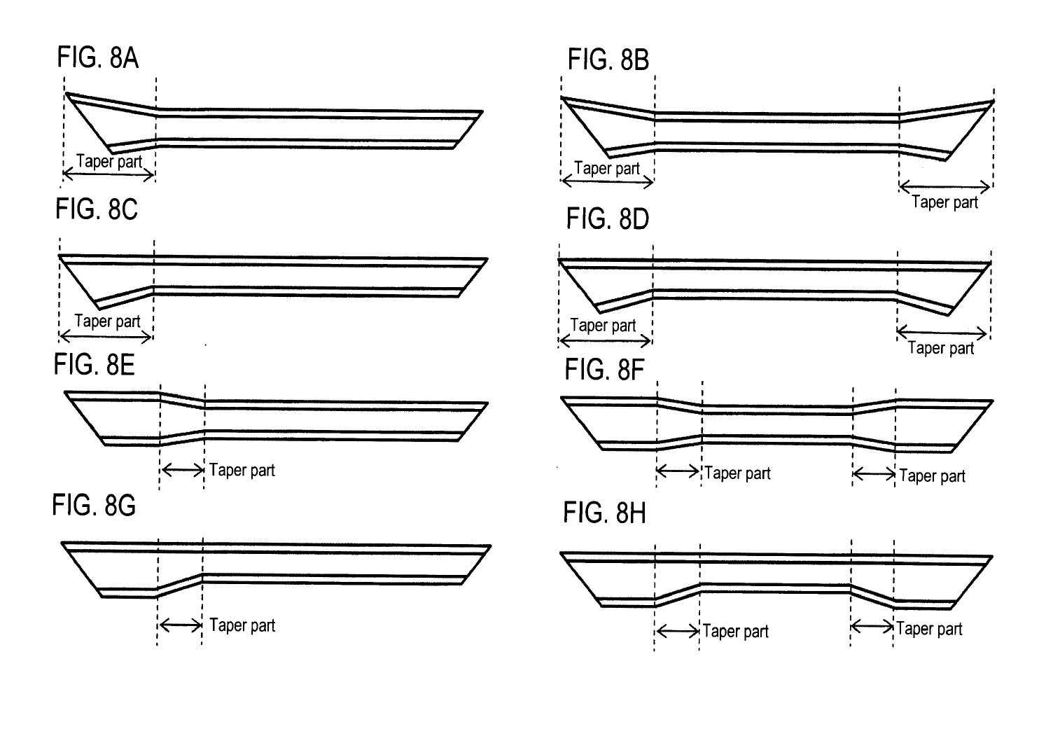

FIGS. 8A to 8H are views showing examples of various shapes of an optical waveguide having a taper part(s). These shapes shown in the figures are just examples, and the present invention is not limited thereto. The optical waveguides of FIGS. 8A and 8B have the shape described in the exemplary embodiment shown FIGS. 1 and 6, respectively. The optical waveguide of FIG. 8C has a taper part at its one side. The optical waveguide of FIG. 8D has taper parts on both sides thereof. In each of the optical waveguides shown in FIGS. 8C and 8D, one side of the taper part (upper side in the figures) has a flat shape. This may eliminate an effect of inclination of a waveguide surface in optical coupling between the taper parts and the light emitting device or the light receiving device. The optical waveguide of FIG. 8E has a taper part on one side, and the optical waveguide of FIG. 8F has taper parts on both sides. In each of the optical waveguides shown in FIGS. 8E and 8F, the taper part(s) are formed at a position(s) spaced from the light reflecting surface to the second waveguide region 2 with a waveguide(s) near the light reflecting surface being formed into a flat shape. In this manner, by configuring the optical waveguide and the light emitting device or the light receiving device such that they can be coupled together in plane, it is possible to eliminate an effect of the inclination of the waveguide surface in optical coupling. The optical waveguide of FIG. 8G has a taper part on one side, and the optical waveguide of FIG. 8H has taper parts on both sides. In each of the optical waveguides shown in FIGS. 8G and 8H, the taper part(s) are formed at a position(s) spaced from the light reflecting surface to the second waveguide region 2 with the entire surface of one side (upper side in the figure) of the optical waveguide being formed into a flat shape. Although the inclination (slope) of the taper parts is shown to be linear in the above examples, the taper parts are not limited thereto and may have an arc shape, for example.

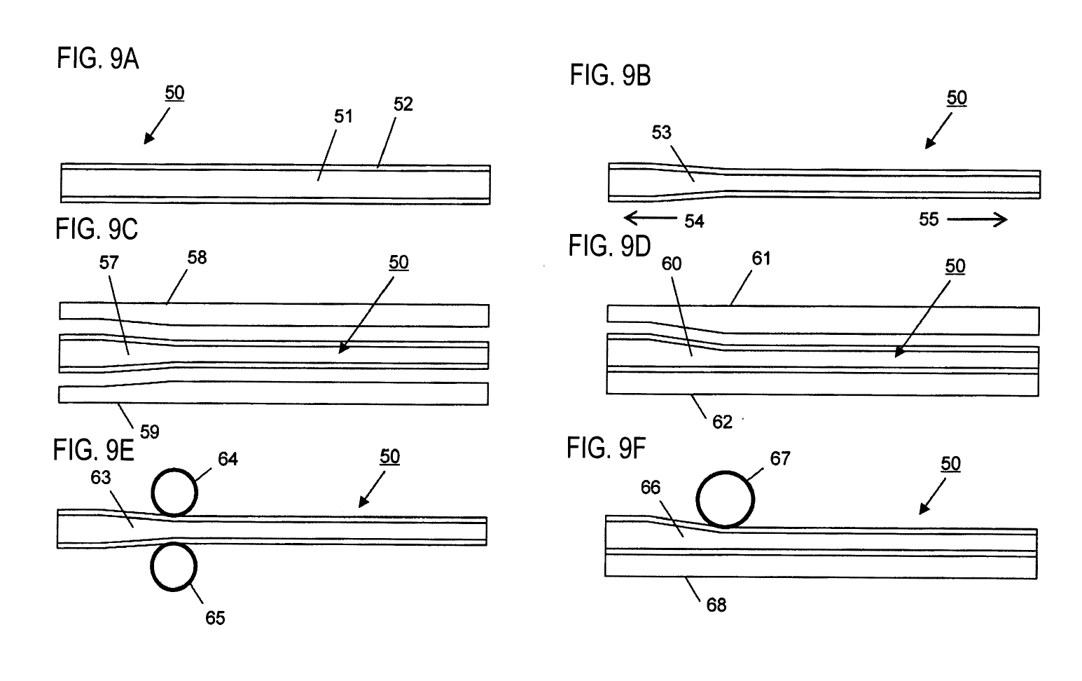

FIGS. 9A to 9F are views showing examples of a method of forming a taper part on an optical waveguide. FIG. 9A shows an optical waveguide 50 including a core 51 and a clad 52 provided on the core 51, before a taper part is formed. FIG. 9B shows an example of forming a taper part 53 on one side of the optical waveguide 50 by means of stretching. In this case, the tension in the direction of an arrow 54 is weaker than the tension in the direction of an arrow 55. FIG. 9C shows a process of pressing the optical waveguide 50 using molds 58 and 59 corresponding to a taper part 57 to be formed. FIG. 9D shows that the optical waveguide 50 is pressed in a way similar to FIG. 9C except that a mold 61 which corresponds to a taper part 60 to be formed and a plane mold 62 are used. FIG. 9E shows a process of forming a taper part in the optical waveguide 50 by pressing the optical waveguide 50 using rolls 64 and 65 so that the taper part 63 is formed. FIG. 9F shows a process of forming a taper part 66 in the optical waveguide 50 by a roll in a way similar to FIG. 9E except that a roll 67 is provided on one side of the optical waveguide and the opposite side thereof is fixed by a flat pedestal 68. As described above, methods of forming a taper part in the optical waveguide include, for example, but not limited to, a method of pressing the optical waveguide using a mold, a method of thinning portions other than the ends of the optical waveguide by means of stretching, a method of thinning the central portion by pressing the optical waveguide toward its leading end using a roll, etc., after manufacturing a parallel optical waveguide.

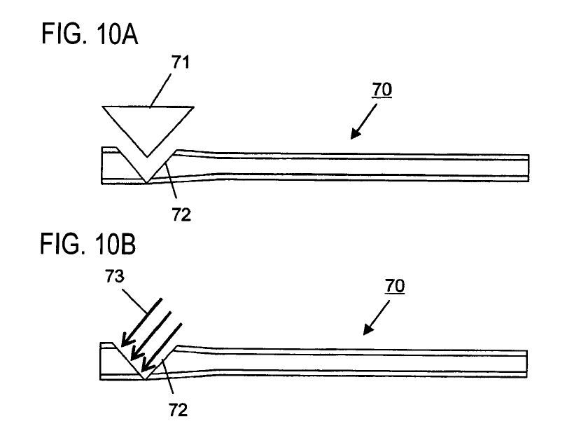

FIGS. 10A and 10B are views showing examples of a method of forming a light reflecting surface on an optical waveguide. FIG. 10A shows that an optical waveguide 70 is diced using a blade 71 whose leading edge angle is 90 degrees. As a result, a 45 degree surface (light reflecting surface) 72 is formed in the optical waveguide 70. FIG. 10B shows that the 45 degree surface 72 is formed by a process using a laser beam 73. A laser used for the laser process may include, for example, an excimer laser, or the like.

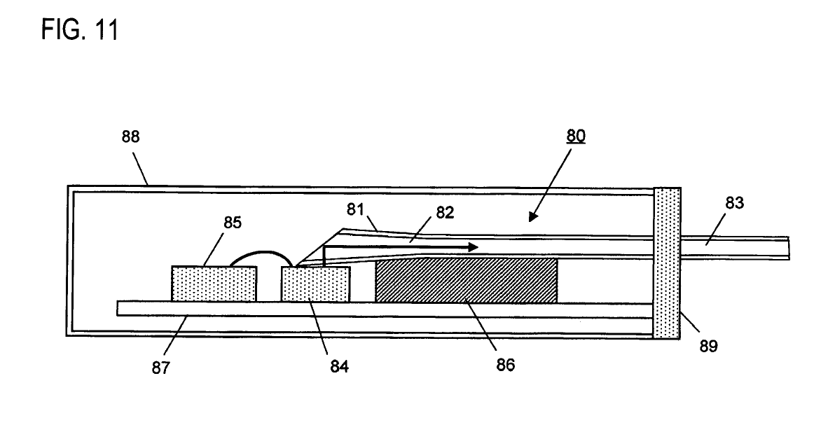

FIG. 11 is a view showing a light transmission apparatus using the optical waveguide according to one exemplary embodiment of the present invention. As shown, the light transmission apparatus of this exemplary embodiment includes an optical waveguide 80 including a first waveguide region 81 having a taper part 82 and a bendable (flexible) second waveguide region 83, and a light emitting device 84 disposed in a direction crossing a waveguide longitudinal direction in a light reflecting surface 83 of the optical waveguide. The light emitting device 84 is driven by a driving circuit 85 such as a driver IC. The light emitting device 84, the driving circuit 85 and the optical waveguide 80 are installed on a substrate 87 via a spacer 86. These components are stored in a module case 88 and the second waveguide region 83 of the optical waveguide 80 extends to the outside of the module case 88 via a fixing part 89. The externally extending second waveguide region 83 of the optical waveguide 80 is bendable and is used with a bent state when the occasion demands. This example is for a transmitter side but may be used for a receiver side with replacement of the light emitting device 84 and the driving circuit 85 with a light receiving device and an amplification circuit, respectively. In addition, a light transmission apparatus which is capable of transmission/reception can be achieved by arranging a light emitting device in a direction crossing the waveguide longitudinal direction in one light reflecting surface of the bendable optical waveguide having the taper part and arranging a light receiving device in a direction crossing the waveguide longitudinal direction in the other light reflecting surface of the optical waveguide.

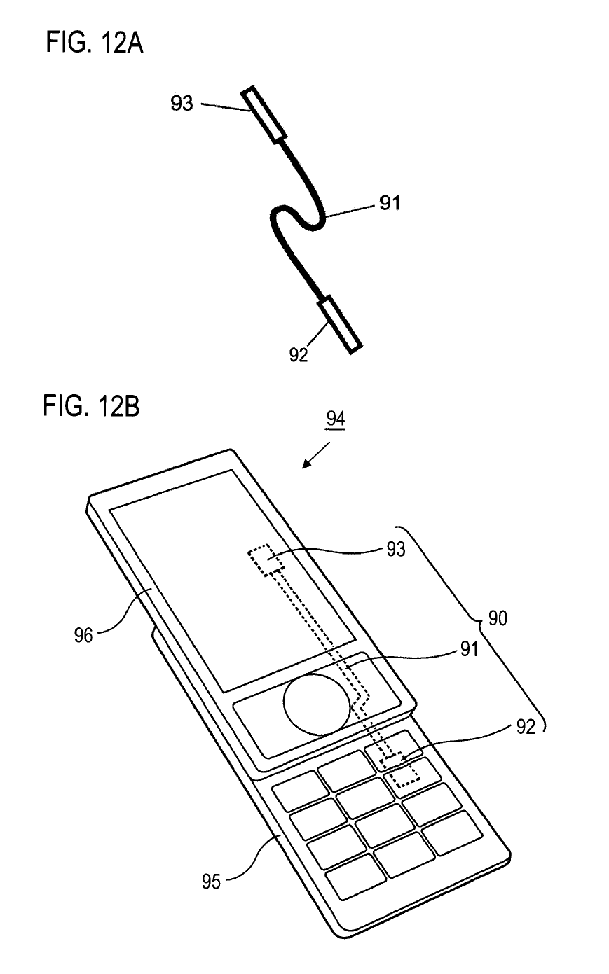

FIGS. 12A and 12B are views showing electronic equipment on which the light transmission apparatus using the optical waveguide is mounted according to one exemplary embodiment of the present invention. FIG. 12A shows a light transmission apparatus having a bendable optical waveguide, and FIG. 12B shows an example where the light transmission apparatus is mounted on a mobile phone as an example of an electronic equipment. As shown in FIG. 12A, a light transmission apparatus 90 includes an optical waveguide 91 having a bent second waveguide region, a transmitter 92 including a light emitting device (not shown) arranged in a direction crossing the waveguide longitudinal direction in one light reflecting surface of the optical waveguide, and a receiver 93 including a light receiving device (not shown) arranged in a direction crossing the waveguide longitudinal direction in the other light reflecting surface of the optical waveguide.

Although the light transmission apparatus 90 is disposed within a mobile phone 94, the light transmission apparatus 90 is highlighted to clarify the disposition state in FIG. 12(b). As shown, the transmitter 92 is provided in an operating part 95 of the mobile phone, the receiver 93 is provided in a display part 96 of the mobile phone, and the transmitter 92 and the receiver 93 are optically coupled to each other via the bent optical waveguide 91. In this example, an operating signal based on the operation of the operating part 95 is transmitted in the form of an optical signal from the transmitter 92 to the receiver 93 through the optical waveguide 91 and is displayed on the display part 96. In this manner, by making the optical waveguide bendable, it is possible to properly arrange the light transmission apparatus even in a narrow place which has a limited mount area. Although electronic equipment is illustrated with a mobile phone in this example, the present invention is not limited to this, but the optical waveguide may be applied to other electronic equipment.

The present invention relates to an optical waveguide, a light transmission apparatus and electronic equipment and has industrial applicability.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An optical waveguide comprising:
a first waveguide region that includes
a first core,
a first clad provided around the first core, and
a light reflecting surface having at least one function of (i) reflecting light from a longitudinal direction of the first core toward a direction crossing the longitudinal direction and (ii) reflecting light from the crossing direction toward the longitudinal direction of the first core; and
a second waveguide region that continues from the first waveguide region, the second waveguide region that includes
a second core, and
a second clad provided around the second core, wherein
the second core of the second waveguide region is thinner than the first core of the first waveguide region, and
a total thickness of the second core and the second clad is smaller than that of the first core and the first clad.

2. The optical waveguide according to claim 1, wherein the first waveguide has a taper part in which the thickness of the first core gets smaller gradually toward the second waveguide region.

3. The optical waveguide according to claim 2, wherein the light reflecting surface is formed at an opposite end of the taper part to the second waveguide region.

4. The optical waveguide according to claim 2, wherein the taper part is formed at a position spaced from the light reflecting surface toward the second waveguide region.

5. The optical waveguide according to claim 2, wherein an inclination of one side of the taper part is larger than that of the other side of the taper part.

6. The optical waveguide according to claim 1, further comprising:
a third waveguide region that continues from the second waveguide region on an opposite side to the first waveguide region, and has an inverse configuration of the first waveguide region in terms of a longitudinal direction of the second core of the second waveguide.

7. A light transmission apparatus comprising:
the optical waveguide according to claim 1; and
a light emitting device that is provided in a direction crossing a longitudinal direction of the first core when viewed from the light reflecting surface of the optical waveguide in the first waveguide region.

8. A light transmission apparatus comprising:
the optical waveguide according to claim 1; and
a light receiving device that is provided in a direction crossing a longitudinal direction of the first core when viewed from the light reflecting surface of the optical waveguide in the first waveguide region.

9. A light transmission apparatus comprising:
the optical waveguide according to claim 6;
a light emitting device that is provided in a direction crossing the waveguide longitudinal direction when viewed from one of the light reflecting surfaces of the first and third waveguide regions; and
a light receiving device disposed in the direction crossing the waveguide longitudinal direction when viewed from the other of the light reflecting surfaces of the first and third waveguide regions.

10. An electronic equipment comprising:
the optical waveguide according to claim 6, the second waveguide region of the optical waveguide being bent;
a transmitter including a light emitting device that is provided in a direction crossing the waveguide longitudinal direction when viewed from one of the light reflecting surfaces of the first and third waveguide regions; and
a receiver including a light receiving device that is provided in the direction crossing the waveguide longitudinal direction when viewed from the other of the light reflecting surfaces of the first and third waveguide regions.
